(19) United States
(12) Patent Application Publication
(10) Pub. No.: US 2008/0071044 A1
(43) Pub. Date: Mar. 20, 2008

(54) Adhesive

(75) Inventors: Klaus Keite-Telgenbuscher, Hamburg (DE); Kertsin Gotz, Hamburg (DE); Stefan Wulf, Monchengladbach (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AG, Hamburg (DE)

(21) Appl. No.: 11/858,268

(22) Filed: Sep. 20, 2007

(30) Foreign Application Priority Data
Sep. 20, 2006 (DE) 10 2006 044 718.2

(51) Int. Cl. C08F 283/12

(52) U.S. Cl. 525/479

(57) ABSTRACT

For improving the joining of pressure-sensitive adhesives to a carrier or substrate, an acrylate-based adhesive having a base adhesive and additives is proposed, its additives including at least one modified polydialkylsiloxane.

The invention relates to an acrylate-based adhesive having a base adhesive and additives, and to an adhesively bondable sheetlike structure having at least one adhesive coating.

Both in modern manufacturing operations and in the household it is no longer possible to imagine life without adhesive bonds based on adhesive tapes. Employed as adhesive tapes are adhesively bondable sheetlike structures furnished on one or both sides with acrylate-based adhesives. Adhesive tapes of this kind typically include a carrier for enhancing the stability, but there are also adhesive transfer tapes, as they are called, which are formed without an additional carrier.

Depending on the surface of the carrier or of the bond substrate it may be difficult to achieve anchorage of the adhesive on the surface.

Thus, when using highly porous carrier materials or when bonding on a porous substrate, a problem which frequently occurs is that a large portion of the adhesive penetrates into the porous structure and so is no longer able to make more than a minor contribution, if any at all, to the formation of an adhesive bond. The lower the viscosity of the adhesive, the more the penetration of the porous matrix becomes a problem. This phenomenon affects in the extreme, for instance, the bonding of sheetlike structures having high-tack adhesives to rough substrates or, for instance, the application of hot-melt adhesives (known as “hotmelts”) to paper carriers in the manufacture of bondable sheetlike structures, of the kind used as adhesive packaging tapes or for bonding the ends of rolls in papermaking.

In order to produce a stable bond in such systems nevertheless, it would be necessary drastically to increase the amount of adhesive applied. For example, when a conventional pressure-sensitive adhesive (PSA) is used for bonding to paper, 20-30 g/m² of the PSA penetrate into the fibre structure of the paper on direct coating, meaning that overall a high adhesive application rate, of well above 50 g/m², is necessary in order to ensure a sufficiently stable bond. Such a thick coating of adhesive, however, cannot be dried without bubbles. Large bubbles occur in the coating, and this cannot be prevented even by adapting the production parameters during application and drying.

In order to reduce or eliminate this disadvantage, namely the penetration of the adhesive into a porous carrier matrix, it is possible prior to the application of the adhesive to apply to the carrier a protective coating as a barrier coat to provide at least partial masking or sealing of the pore structure. As a result of the poorer adhesion of the adhesive to the barrier coat, however, the anchorage of the adhesive on the carrier is poor, so that, when the sheetlike structure is removed, the adhesive is not removed together with the carrier but instead remains on the substrate; there is what is called a transfer of the adhesive from the carrier to the substrate. With systems of this kind, therefore, detachment of the sheetlike structure without residue is not possible. Moreover, this method cannot be used to prevent the penetration of the adhesive into a porous substrate. Even in the case of very smooth surfaces of this kind, therefore, the problem of adhesive anchorage persists.

It is an object of the invention to provide an acrylate-based adhesive which allows a stable joining of the adhesive to a joining surface such as the substrate or to a carrier. The invention ought further to provide an adhesively bondable sheetlike structure for stable joining to the joining surface, allowing easy bonding and residue-less redetachment from the substrate.

Surprisingly, and in a way which was not obvious for the person skilled in the art, this object is achieved in accordance with the invention through an acrylate-based adhesive having a base adhesive and additives, the additives including at least one modified polydialkylsiloxane. The use of polydialkylsiloxanes as additives for acrylate-based adhesives on the one hand offers a stable join to a substrate, and also a firm anchorage to a carrier, without detracting from the adhesive properties of the base adhesive or from its mechanical properties. In particular the acrylate-based adhesive of the invention features high tack, high holding power and high bond strength to label paper. As a result of the composition of the invention, the formation of a stable join is therefore made much easier, since the attainment of an adhesive bond or anchorage of this kind does not necessitate additional preparation steps such as the application of a primer or a physical surface treatment (e.g. corona treatment).

The use of modified polydialkylsiloxanes of this kind is especially advantageous in the case of what are called 100% systems, i.e. in the case of straight acrylate adhesives, in other words adhesives without addition of solvent or dispersion medium, and in the case of solvent-based acrylate adhesive, since with adhesives of that kind in particular it is virtually impossible to alter the anchoring properties without altering the adhesive properties in another way.

In one advantageous embodiment the at least one modified polydialkylsiloxane has as its modification side chains which include polar groups. In this way, improved compatibility and a high bond strength of the acrylate-based adhesive to polar surfaces are obtained, as is, therefore, a stable join of the acrylate-based adhesive to polar joining surfaces.

It is advantageous here if the side chain which includes polar groups is a polyether side chain. In that way the compatibility becomes particularly good and the join between the adhesive and the joining surface becomes particularly stable, without any adverse effect on the bond strength of the acrylate-based adhesive. It is especially advantageous for this purpose if the polyether side chain includes alkanediols with a linear carbon chain which are linked to one another by ether bonds, and if the polyether side chain is joined to the polysiloxane main chain via an alkylene chain. This is particularly efficient at preventing transfer of the acrylate-based adhesive.

Also particularly suitable is an acrylate-based adhesive wherein the at least one modified polydialkylsiloxane includes as its modification alkyl side chains substituted by aryl groups. In that way high bond strength of the acrylate-based adhesive to apolar surfaces and hence a stable join of the acrylate-based adhesive to apolar joining surfaces are obtained.

It is advantageous, furthermore, if the modified polydialkylsiloxane is a modified polymethylalkylsiloxane or even a modified polydimethylsiloxane. One of the effects of this is to ensure that the additives are embedded well into the adhesive. The type of alkyl group used otherwise depends in each case on the specific composition of the adhesive.

The acrylate-based adhesive of the invention is especially suitable when, in the acrylate-based adhesive, the at least one modified polydialkylsiloxane is present at a fraction of at least 0.005% and not more than 2% by weight. This ensures on the one hand that the join to the porous joining surface is particularly good, but on the other hand also that the adhesive overall exhibits high bond strength with sufficient tack.

It is advantageous, moreover, if the base adhesive includes a base polymer based on acrylic monomers and also, optionally, on vinyl monomers. Particularly preferred acrylic monomers are those selected from the group encompassing acrylic acid, methacrylic acid, butyl acrylate and ethylhexyl acrylate. A base adhesive of this kind is especially suitable for bonding to paper and also for anchorage to paper carriers, especially those of coated paper. The acrylate-based adhesive of the invention, accordingly, ensures particularly effective joining to a joining surface of paper in conjunction with outstanding depulpability of the adhesive at the same time.

Finally, the acrylate-based base adhesive can with advantage also be a pressure-sensitive adhesive. This adhesive remains permanently tacky after application to the carrier, and can be applied under pressure to a substrate, where it is able to enter into a bond with the substrate. Through the use of a PSA as base adhesive, particularly simple bonding of the acrylate-based adhesive to different substrates becomes possible.

The invention further provides a bondable sheetlike structure having at least one adhesive coating, the adhesive coating including at least one of the acrylate-based adhesives described above. This simplifies the use of the adhesive of the invention. The resulting adhesive tape offers all of the advantages described above, more particularly a sufficiently low transfer propensity in tandem with high bond strength and tack.

Employed by way of additive, in accordance with the invention, is at least one modified polydialkylsiloxane. A modified polydialkylsiloxane is understood to be a compound which has as its parent structure an unsubstituted polydialkylsiloxane in which some of the alkyl groups have been replaced by modifying side chains. The polydialkylsiloxane parent structure formed here is arbitrary: linear, branched, cyclic or comblike, for instance.

As well as the polydialkylsiloxane parent structure a modified polydialkylsiloxane of this kind may at the same time also include further parent structures. Thus, in accordance with the invention, the modified polydialkylsiloxane may take the form of a block copolymer where at least one of the polymer blocks has a parent structure composed of an unsubstituted polydialkylsiloxane in which some alkyl groups have been replaced by modifying side chains. This at least one polymer block and also further polymer blocks of a modified polydialkylsiloxane block copolymer of this kind may, furthermore, also contain further monomers, based for instance on unsaturated organic compounds, examples being acrylic monomers or vinyl monomers.

The unsubstituted polydialkylsiloxanes (silicones) of the parent structures have chains composed of oxygen-bridged silicon atoms as subunits. Within the chains, each silicon atom, with the exception of those at branching points or at the chain end, has two bridging oxygen atoms and also two identical or different alkyl groups. Via each of the bridging oxygen atoms the silicon atom is joined to an adjacent silicon atom. An unmodified subunit U⁰ of this kind therefore has the general formula -[—Si(A¹)(A²)—O—]-, where A¹ and A² represent the above-described alkyl groups. In the case of unmodified subunits located at a branching point of the chain, one of the two alkyl groups, A¹ or A², has been replaced by a polydialkylsiloxane secondary chain branching off from the main chain; if appropriate, both alkyl groups, indeed, have been replaced by polydialkylsiloxane secondary chains. Unmodified subunits which are terminal in relation to the polydialkylsiloxane chain may be attached via the bridging oxygen atom or else, in deviation from the general formula, directly to a terminating radical (T¹, R²).

The alkyl groups A¹ and A² may be saturated or unsaturated, unbranched or branched, substituted or unsubstituted alkyl groups having one to thirty carbon atoms, typically an alkyl group having one to eighteen carbon atoms (a C₁ to C₁₈ alkyl group), more favourably a C₁ to C₁₂ alkyl group and preferably a C₁ to C₈ alkyl group, for example methyl, ethyl or propyl groups.

The alkyl groups A¹ and A² here may be identical or different. It is also possible for alkyl group A¹, attached to a silicon atom within a polydialkylsiloxane chain, to be the same as or different from an alkyl group A¹ attached to a different silicon atom within the same polydialkylsiloxane chain; the same applies to A² Particularly suitable polydialkylsiloxanes are those whose parent structure contains one or two methyl groups, in other words polymethylalkylsiloxanes or polydimethylsiloxanes.

In a modified polydialkylsiloxane as compared with an unmodified polydialkylsiloxane, some of the unmodified subunits have been replaced by modified subunits, so that as well as the unmodified subunits the polydialkylsiloxane also includes modified subunits.

The modified subunits differ from the unmodified subunits in that one of the alkyl groups, A¹ or A², or in fact both of them, has or have been replaced by modifying side groups. A modified subunit of this kind, U^{M}, therefore has the general formula -['Si(A³)(M)—O—]-, M being a modifying side group and A³ being an alkyl group of the type described for the alkyl groups A¹ and A², which may be identical to or different from one or both alkyl groups A¹ and A². Typically A³ is a methyl group.

As modifying side chains M it is possible to use all suitable side chains, both apolar and polar. Apolar side chains which can be used are all suitable apolar groups. By way of example it is possible for this purpose to use alkyl groups and/or aryl groups and/or aryl-substituted alkyl groups, more particularly a linear alkylene chain one end of which is attached to the silicon atom of the main chain and the other end of which is joined to an aryl group Ar (aralkyl groups or aryl-alkylene groups), i.e. groups of the general formula —(CH₂)ₙ—Ar where n is the number of divalent methylene groups in the divalent alkylene chain and Ar is the aryl group. Alkyl groups and aryl groups here may additionally each have one or more methyl group substituents.

Suitable alkyl groups include all saturated or unsaturated, unbranched or branched, substituted or unsubstituted alkyl groups, for instance those having one to thirty carbon atoms, typically C₁ to C₃ alkyl groups.

Depending on the specific application, different aromatic hydrocarbon groups may be used as aryl groups, examples being phenyl groups, naphthyl groups and anthryl groups. These groups may each be in substituted or unsubstituted form, it being possible for one hydrogen atom or two or more hydrogen atoms to be substituted, by methyl groups, ethyl groups, halogen atoms or the like, for example, such as trifluorophenyl groups.

As modifying side chains M it is alternatively possible to use polar side chains. As polar side chains use may be made of all polar-functionalized side chains, examples being those containing one or more carboxyl, sulphonic acid, phosphonic acid, hydroxyl, lactam, lactone, N-substituted amide, N-substituted amine, carbamate, epoxy, thiol, alkoxy, cyano, halide or ether groups. Suitable side chains include alkyls substituted by polar groups, or polyesters, polyethers, polythioethers, polyamides and the like.

Thus as a polyester side chain it is possible for example to use aliphatic, cycloaliphatic or aromatic carboxylic esters, such as polycaprolactones and polybutylene adipates. The average molar mass Mn of this polyester side chain is in a range of 200-3000 g/mol. Polyesters which have emerged as being favourable in this context are those which have at least three ester groups, in other words one or both of the groups —C(O)O— and —OC(O)—, joined to one another linearly in each case via alkylene chains, typically C₂ to C₁₂ alkylene groups, more particularly C₄ to C₆ alkylene groups, such as divalent pentylene —(CH₂)₅—. Likewise advantageous are those polyester groups of the general form -[—O—C(O)-E¹-C(O)—O-E²-O—]ⱼ-E³, where j represents the number of polyester units and is chosen to be greater than 2, and where the groups E¹, E² and E³ are selected from substituted and/or unsubstituted alkylene groups.

As the polyether side chain it is possible to use diols, aromatic diols or alkanediols for instance, that are linked to one another via ether bonds. The alkanediols, as structural elements of the polyether, may have saturated or unsaturated, unbranched or branched, substituted or unsubstituted carbon frameworks with one to twelve carbon atoms, but preferably with two to eight carbon atoms, and with a linear carbon chain, such as ethylene glycol, propanediol or butanediol. The positioning of the two hydroxyl groups is arbitrary; use is made typically of those diols having hydroxyl groups in α,β position or in α,ω position. The alkanediols with hydroxyl groups in α,β position can be described by the general formula HO—CH₂—CH(L)—OH, L, for the particularly preferred monomers ethylene glycol, propylene glycol and butanediol, corresponding to a hydrogen atom, a methyl group or an ethyl group, respectively.

A polyether side chain here may encompass identical alkanediols or else different alkanediols, with possible preference in the latter case being given to an alkanediols linkage which is regular in terms of their sequence, or else to a random linking. The polyether side chains in the modified polydialkylsiloxane preferably include ethylene glycol as a monomer at a fraction of 30 mol %.

Depending on application it is possible for different numbers of alkanediols to be linked to one another in the polyether side chain. Typical in this context is a number of at least one and not more than 50, in particular between 5 and 15 or between 10 and 50 alkanediols.

Both the polar-modifying and the apolar-modifying side chains may either be attached directly to the silicon atoms of the polydialkylsiloxane or else attached to the silicon atoms via a further divalent linking group which may consist of an oxygen atom, of alkylene groups, of alkylene ether groups, alkylene thioether groups, alkylenamide groups or the like.

Suitable alkylene groups include all saturated or unsaturated, unbranched or branched, substituted or unsubstituted divalent alkylene groups having 1 to 14 carbon atoms, preferably having 2 and 11 carbon atoms and with particular preference having 3 and 6 carbon atoms.

Suitable alkylene ether groups include those, for instance, having between 2 and 14 carbon atoms, preferably between 2 and 11 carbon atoms, and more preferably between 2 and 4 carbon atoms, an example being —(CH₂)₂—O—(CH₂)₄—.

Suitable alkylene thioether groups include those, for instance, having between 2 and 14 carbon atoms, preferably between 2 and 11 carbon atoms, and more preferably between 2 and 4 carbon atoms, an example being —(CH₂)₂—S—CH₂—.

Suitable alkylenamide groups include those, for instance, having between 2 and 14 carbon atoms, preferably between 2 and 11 carbon atoms, and more preferably between 2 and 4 carbon atoms, an example being —(CH₂)₃—NH—CH₂— or —(CH₂)₃—NH—C(O)—.

On the side opposite the side attached to the silicon atoms of the polydialkylsiloxane, the side chain may additionally be unsubstituted or may have as substituents one or more functional terminal groups, such as a hydroxyl, carboxyl, isocyanate, vinyl or propenyl group, for example. In the case of polyether side groups, moreover, the substituents may also be C₁ to C₂₂ alkyl groups, phthalic ester groups, —PO₃H₂, —C(O)—CH═CH—C(O)OH, —C(O)—CH₂—CH₂—C(O)OH, including more particularly methyl groups, n-butyl groups and acetoxy groups. Furthermore, in the case of polyether side groups, the functional terminal groups may be joined to the polyether section of the side chain optionally via intermediate groups of the general type -(—C(O)—(CH₂)₄—O—)ₖ or -(—C(O)—(CH₂)₅—O—)ₖ—.

As well as unmodified subunits, therefore, the modified polydialkylsiloxane may include either polar-modified subunits or apolar-modified subunits, or even both: polar-modified subunits and apolar-modified subunits.

As linear polydialkylsiloxanes, therefore, the modified polydialkylsiloxanes of the invention may have the general formula T¹-[(U⁰)ₓ,(U^{M})_{y}]-T². The notation [(U⁰)ₓ,(U^{M})_{y}] here indicates that the sequence of unmodified subunits and modified subunits within the polydialkylsiloxane chain can be either regular or else statistical. The average molar fractions are provided by the index x for the unmodified subunits and by the index y for the modified subunits. As branched or cyclic polymers, and also as block copolymers, the polydialkylsiloxanes can be described by analogous general formulae.

The terminal groups T¹ and T² may be selected identically or differently. For instance, the terminal groups T¹ and T² may be selected from the group encompassing a hydrogen atom, alkyl, alkoxy or acid groups and the like. By way of example T¹ and/or T² may each be a methyl, ethyl, isopropyl, hydroxyl, methoxy, ethoxy, isopropoxy, sulphonic acid, phosphonic acid or other acid group, without this enumeration representing any restriction. Furthermore, as terminal groups T¹ and/or T², it is of course also possible for one or more of the above-described modifying side chains to be present. Typically T¹ and T² are methyl groups.

The specific values adopted by x and y are arbitrary and are guided by the particular application. Typical values for x are between 3 and 250, more particularly between 4 and 150, and typical values for y are between 0 and 50, more particularly between 1 and 6; it should be noted that y only adopts a value of 0 when either one or both of the terminal groups T¹ and T² is/are a modifying side chain, so that a modified polydialkylsiloxane always has at least one modifying side chain.

The ratio of unmodified subunits to modified subunits can be selected, in accordance with the desired applications, from a wide range, and is adapted to the respective applications. The modified polydialkylsiloxane typically comprises more unmodified subunits than modified subunits. Thus in a polar-modified polydialkylsiloxane, for instance, a ratio of unmodified subunits to modified subunits from a range from 2 to 40 is typical, more particularly from a range from 3 to 30, and with particular preference from a range from 3 to 15. In an apolar-modified polydialkylsiloxane typically up to 20% by weight of the alkyl groups A¹ and A² present in the unmodified subunits are replaced by modifying side chains.

The polydialkylsiloxanes are supplied to the adhesive in a suitable amount. For use in conventional systems, a fraction of at least 0.005% and not more than 2% by weight has emerged as being particularly advantageous. Below 0.005% by weight the observed effect is too small, while above 2% by weight the adverse effect of the tack increases as a result of the additive, so that it becomes more difficult as a result to achieve an adhesive bond.

An acrylate-based adhesive for the purposes of this invention is any adhesive which, in addition to other, optional ingredients, includes a base adhesive whose adhesive properties are determined, or at least not insubstantially co-determined, by a polymer whose backbone features acrylic monomers.

The group of the acrylic monomers is composed of all compounds having a structure which can be derived from the structure of unsubstituted or substituted acrylic or methacrylic acid or else from esters of those compounds, and which can be described by the general formula CH₂═C(R¹)(COOR²), where the radical R¹ can be a hydrogen atom or a methyl group and the radical R² can be a hydrogen atom or else is selected from the group of saturated, unbranched or branched, substituted or unsubstituted C₁ to C₃₀ alkyl groups. The polymer of the base adhesive of the acrylate-based adhesive preferably has an acrylic monomers content of 50% by weight or more.

As acrylic monomers it is possible in principle to use all of the above-described group of these compounds, their specific selection and their proportions being governed by the particular requirements from the intended sphere of application.

Thus as acrylic monomers it is also possible, for instance, to use those acrylic and methacrylic esters in which the radical R² is selected from the group of saturated, unbranched or branched, substituted or unsubstituted C₄ to C₁₄ alkyl groups, more particularly C₄ to C₉ alkyl groups. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, such as isobutyl acrylate, 2-ethylhexyl acrylate, 2-ethylhexyl methacrylate, isooctyl acrylate, isooctyl methacrylate, and also cyclohexyl methacrylate, isobornyl acrylate, isobornyl methacrylate or 3,5-dimethyladamantyl acrylate.

Also suitable, for instance, are monofunctional acrylates or methacrylates wherein the radical R² is selected from the group of bridged or unbridged cycloalkyl radicals having at least six carbon atoms. The cycloalkyl radicals can of course also be substituted, by C₁ to C₆ alkyl groups, halogen atoms or cyano groups for instance. Specific examples are cyclohexyl methacrylate, isobornyl acrylate, isobornyl methacrylate and 3,5-dimethyladamantyl acrylate.

In one preferred procedure use is made of acrylic monomers which have one or more substituents, more particularly polar substituents, examples being carboxyl, sulphonic acid, phosphonic acid, hydroxyl, lactam, lactone, N-substituted amide, N-substituted amine, carbamate, epoxy, thiol, alkoxy, cyano, halide and ether groups.

As adhesive component it is possible for example to use a polymer which comprises at least one acrylic monomer in which R² is selected from the group of saturated, unbranched or branched, substituted or unsubstituted C₂ to C₂₀ alkyl groups, and at least one comonomer which is copolymerizable with the at least one acrylic monomer and which can be selected in particular from vinyl compounds having functional groups, maleic anhydride, styrene, styrene compounds, vinyl acetate, acrylamides or photoinitiators functionalized with a double bond. The proportions of these constituents can be varied within a wide range. For example the acrylic monomer may account for a mass fraction of 65% to 100% by weight and the at least one comonomer for a mass fraction of 0% to 35% by weight in the polymer of the base adhesive.

Comonomers which can be used in this context include all suitable above compounds, for instance those having one or more substituents, more particularly polar substituents such as, for instance, carboxyl, sulphonic acid, phosphonic acid, hydroxyl, lactam, lactone, N-substituted amide, N-substituted amine, carbamate, epoxy, thiol, alkoxy, cyano, halide and ether groups.

Likewise suitable as comonomers are, for example, moderately basic comonomers such as singly or doubly N-alkyl-substituted amides, more particularly acrylamides. Specific examples are N,N-dimethylacrylamide, N,N-dimethylmethacrylamide, N-tert-butylacrylamide, N-vinylpyrrolidone, N-vinyllactam, dimethylaminoethyl acrylate, dimethylaminoethyl methacrylate, diethylaminoethyl acrylate, diethylaminoethyl methacrylate, N-methylolacrylamide, N-methylolmethacrylamide, N-(butoxymethyl)methacrylamide, N-(ethoxymethyl)acrylamide, and N-isopropylacrylamide, this enumeration not being exhaustive.

Further suitable examples of comonomers, on the basis of functional groups which can be utilized for crosslinking, are hydroxyethyl acrylate, hydroxyethyl methacrylate, hydroxypropyl acrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl acrylate, 2-butoxyethyl methacrylate, cyanoethyl acrylate, cyanoethyl methacrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, and dimethylacrylic acid, this enumeration not being exhaustive.

Further suitable comonomers include vinyl compounds, more particularly vinyl esters, vinyl ethers, vinyl halides, vinylidene halides, vinyl compounds with aromatic rings and heterocycles in a position. Here as well mention may be made, non-exclusively, of certain examples, such as vinyl acetate, vinylformamide, vinylpyridine, ethyl vinyl ether, vinyl chloride, vinylidene chloride, styrene and acrylonitrile.

Other examples of such comonomers may be photoinitiators having a copolymerizable double bond, more particularly those selected from the group containing Norrish I or Norrish II photoinitiators, benzoin acrylates or acrylated benzophenones.

It is also possible as well to add further monomers, possessing a high static glass transition temperature, to the abovementioned comonomers. Suitable such components include aromatic vinyl compounds such as styrene, for example, the aromatic nuclei preferably being composed of C₄ to C₁₈ units and being also able to contain heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, tert-butylphenyl acrylate, tert-butylphenyl methacrylate, 4-biphenylyl acrylate and 4-biphenylyl methacrylate, 2-naphthyl acrylate and 2-naphthyl methacrylate, and mixtures of such monomers, this enumeration not being exhaustive.

Suitable adhesives are therefore those having as their base polymer a polymer formed on the basis of acrylic monomers and also—optionally—vinyl monomers. Acrylic monomers employed may be, as described above, especially acrylic acid, methacrylic acid, butyl acrylate and ethylhexyl acrylate. Depending on the intended use, these constituents may be used within a wide range. For instance, a base polymer of this kind may include 30% to 60% acrylic acid, 30% to 60% butyl acrylate, 0% to 40% ethylhexyl acrylate and 0% to 10% by weight vinyl monomer, all percentages being by weight. Other base polymers, given purely by way of example, include about 50% to 90% acrylic acid, 10% to 50% butyl acrylate and 0% to 10% vinyl monomer, or 50% to 90% acrylic acid, 30% to 5% butyl acrylate, 30% to 5% ethylhexyl acrylate and 0% to 10% by weight vinyl monomer, again all percentages being by weight, and this enumeration being by no means complete.

Particularly suitable base polymers are those acrylate-based polymers obtainable for instance by means of free-radical addition polymerization.

Furthermore, the base adhesive may also include further formulating ingredients, such as plasticizers or crosslinkers. One example of a base adhesive of this kind is an adhesive including 25% to 45% by weight of the above-described polymer of acrylic monomers and of optional vinyl monomers, typically 30% to 35% by weight; 55% to 75% by weight of a plasticizer such as ethoxylated C₂₀ alkylamine, for instance, typically 65% to 70% by weight; and 0.5% to 1.5% by weight of a crosslinker, typically 0.5% to 1.0% by weight. Apart from the restriction to the acrylate-based base polymer, the base adhesive may feature any desired compositions of typical adhesives and any desired properties of typical adhesives. Thus, for instance, a pressure-sensitive adhesive may be used as the base adhesive. Pressure-sensitive adhesives (PSAs) have a permanent pressure-sensitive adhesive action at room temperature; that is, they have a sufficiently low viscosity and a high tack, so that they wet the surface of the respective bond substrate even with a small applied pressure.

Besides the base adhesive and the modified polydialkylsiloxanes, the acrylate-based adhesive of the invention can of course also feature further adjuvants, such as, for example, fillers, pigments, Theological additives, adhesion-promoting additives, plasticizers, resins, elastomers, ageing inhibitors (antioxidants), light stabilizers, UV absorbers, and other auxiliaries and adjuvants, examples being driers (for instance molecular sieve zeolites or calcium oxide), flow agents and flow control agents and/or wetting agents such as surfactants, or catalysts.

A suitable bondable sheetlike structure is any sheetlike structure formed with the acrylate-based adhesive of the invention. It may either be of carrier-free design (i.e. contain no separate carrier), in the form for example of an adhesive transfer tape, or else may have a carrier. The sheetlike structure is of sheetlike design, in the form for instance of a tape, label, label diecut or sheet.

Moreover, the bondable sheetlike structure can of course also comprise more than one adhesive, in the case, for instance, of its use as a double-sided adhesive tape. A further possibility is for the bondable sheetlike structure to be coated on one side or, in the last-mentioned example, on both sides with a temporary release agent in the form of a liner, such as with a siliconized release paper or the like.

The carrier may be composed of all typical carrier materials, both rigid and flexible: for example, of sheets of polyvinyl chloride, polypropylene, cellulose acetate or polyester, of paper, of woven fabric and the like. Where a carrier coated with adhesive on one side only is used, the carrier may also be unilaterally siliconized on the side not coated with adhesive.

To promote the adhesion of the acrylate-based adhesive to a polymeric carrier sheet, the sheet may have been provided on one or both sides with an adhesion promoter, referred to as a primer. Primers which can be used are typical primer systems, such as heat-sealing adhesives, based on polymers such as ethylvinyl acetate or functionalized ethylvinyl acetates, or else reactive polymers. Functional groups which can be used in this context are all typical adhesion-promoting groups, such as epoxide, aziridine, isocyanate or maleic anhydride groups. Moreover, additional crosslinking agents may also be added to the primers, examples being melamine resins or melamine-formaldehyde resins. For polyethylene naphthalate carrier sheets, highly suitable primers are those based on polyvinylidene chloride and copolymers of vinylidene dichloride, more particularly with vinyl chloride (such as Saran from The Dow Chemical Company).

Further advantages and application possibilities are apparent from the working examples, which are described in more detail below.

The base adhesives used were two different acrylate-based systems in each of which the same conventional base polymer was used. The base polymer contained 50.0% by weight 2-ethylhexyl acrylate, 45.0% by weight acrylic acid and, as a vinyl comonomer, 5.0% by weight N-vinylcaprolactam.

Base adhesive 1 used was a composition of 33.0% by weight base polymer, 66.0% by weight plasticizer and 1.0% by weight crosslinker.

Base adhesive 2 used was a composition of 34.0% by weight base polymer, 65.5% by weight plasticizer and 0.5% by weight crosslinker.

Both compositions were dissolved with a solids content of 30% in a solvent mixture of acetone, isopropanol and water in a ratio of 1:1:1.

As a consequence of the significantly different amounts of crosslinker, the two base adhesives differed greatly in terms of their adhesive properties.

The plasticizer used was a hydroxyl-containing ethoxylated C₁₂ alkylamine (“Sinopol” from Vink & Co. GmbH). The crosslinker employed was aluminium acetylacetonate.

To obtain the acrylate-based adhesive of the invention in each case, modified polydialkylsiloxanes were added in different proportions to the base adhesives. Polydialkylsiloxanes were added in an amount of 0.0% to 1.0% by weight to the base adhesive, the amount being based in each case on the mass of the liquid adhesive. The result obtained without polydialkylsiloxane was used in each case as a standard for comparison.

The polar-modified polydialkylsiloxane used was a polyether-modified polydimethylsiloxane of the general formula (H₃C)₃Si—O—[—Si(CH₃)(M)—O—]_{y}-[—Si(CH₃)₂—O—]ₓ—Si(CH₃)₃ with M as the polar-modifying side chain of the above-described type -(—(CH₂)ₘ—O—[—CH₂—CH(L)-O—]—Z (BYK-306 from BYK Chemie GmbH). The apolar-modified polydialkylsiloxane used was an aralkyl-modified polymethylalkylsiloxane of the general formula (H₃C)₃Si—O—[—Si(CH₃)(M)-O—]_{xy}-[—Si—CH₃)(Q)-O—]ₓ—Si(CH₃)₃ with Q as the alkyl group of the above-described kind and M as the apolar-modifying side chain of the above-described kind —(CH₂)ₙ—Ar (BYK-322 from BYK Chemie GmbH).

In addition, comparative experiments were carried out with different additives which are used for similar purposes, namely for the anchoring of printing inks and paints. The additives in question are the products BYK-358N and BYK-388 from BYK Chemie GmbH and also the product Zonyl FSG from Tego Chemie Service GmbH. The comparison additives were added to the base adhesives in each case in a fraction of 0.2% and 1.0% by weight (based on the mass of the liquid adhesive).

In some cases the polydialkylsiloxanes and the comparison additives were present in solution. In that case the quantities indicated in the formulas relate to the amount of the solution.

The additives were added in the desired concentration to the liquid base adhesives and the resulting adhesive, following intensive mixing, was applied by direct coating to the carrier used, to give bondable sheetlike structures. The application rate of the drying in these cases was 50 g/m².

The carrier used was paper provided on one side with a preliminary coat of polyvinyl alcohol (PVOH) (basis weight of paper 120 g/m², thickness 150 μm, manufacturer: Thilmany Pulp & Paper). Coating with the adhesive took place over the preliminary PVOH coat.

After the crosslinking and conditioning of the acrylate-based adhesives on the bondable sheetlike structure, the bondable sheetlike structures were equilibrated for five days under standard conditions, and then their adhesive properties were ascertained.

The investigations encompassed the determination of the bond strength, tack, holding power, repulpability and adhesive anchorage.

The bond strength was determined here as follows: An uncoated label paper was used as a defined substrate for attachment. The bondable sheetlike structure under investigation was cut to a width of 20 mm and a length of approximately 25 cm, a handling section was attached, and immediately thereafter the structure was pressed onto the paper substrate ten times using a 4 kg steel roller with a rate of advance of 10 m/min. Immediately thereafter the bondable sheetlike structure was removed from the substrate at an angle of 180° and the force required to achieve this at room temperature was recorded. The measured value (in N/cm) resulted as the average value from three individual measurements.

The tack was determined as follows: As a measure of the tack in the case of a very short contact time, the parameter measured was the rolling ball tack. A strip of the bondable sheetlike structure approximately 30 cm long was fixed horizontally, with the adhesive side upwards, on the test plane. A steel sample ball (diameter: 11 mm; mass: 5.6 g) was cleaned with acetone and conditioned for 2 hours under standard conditions (temperature: 23° C.±1° C.; relative humidity: 50% ±1%). For the measurement, the steel ball was accelerated by rolling down a ramp which was 65 mm high (angle of inclination: 21°) under the Earth's gravity. From the ramp the steel ball was steered directly onto the adhesive surface of the sample. The distance travelled on the adhesive until the ball reached standstill was measured. The rolling distance determined in this way serves as an inverse measure of the tack of the self-adhesive composition (i.e. the shorter the distance the higher the tack, and vice versa). The measured value in each case resulted (as a reported length in mm) from the average of five individual measurements on five different strips of the bondable sheetlike structure.

The shear strength of the bondable sheetlike structure was determined in the form of the holding power (shear withstand time) on a paper substrate. Paper substrates were white coating base paper having an a real density of 60 g/m² (SRP) and gravure paper having an a real density of 54 g/m² (Turnopress from StoraEnso) (TDP). For the measurement, a strip of the bondable sheetlike structure with a width of 13 mm and a length of 20 mm was applied to the paper substrate and pressed on with a constant applied pressure four times in machine direction using a 2 kg steel roller with a rate of advance of 300 mm/min. At room temperature, the bondable sheetlike structure was loaded with a constant shearing load, and the time until it sheared off was measured as the holding power (in minutes). The respective holding power values result in this case as the average from three measurements.

For the qualitative determination of the reprocessability of water-dispersible bondable sheetlike structures and papers, the bondable sheetlike structure under test is processed together with a special cellulose to form a paper slurry in suspension in water, the pulp, from which a new sheet of paper is produced. This sheet is examined for sticky and non-sticky fibre bundles (known as lumps) and tested for residual stickiness. The product under test is said to be repulpable (evaluation: +) if the sheet produced exhibits neither lumps to a substantial extent nor pronounced residual stickiness. For testing purposes the bondable sheetlike structure is bonded to the cellulose and divided into squares with a 13 mm edge length. Further cellulose is added to this specimen to give a total specimen mass of 15 g. The specimen is beaten with mains water in a beating vessel. Using a sheet former, a sheet is made from the resulting pulp, and is lined with a top sheet and with card. The sheet samples thus obtained are assessed on at least two test sheets per sample. The top sheet and card are carefully removed from the sheet sample. An investigation is made of the number of lumps which stick to the top sheet or to the liner card. The sheets obtained in this way are assessed qualitatively in both transmitted light and incident light.

To investigate the adhesive anchorage, a set of three sections of the bondable sheetlike structure with a width of 20 mm and a length of 25 cm is adhered to coated base paper (DIN A4, such as Mediaprint TCF Seidenmatt 200 g/m²) and pressed on quickly twice using a 4 kg steel roller. One of the three sections in each case is investigated by peeling from the base paper by hand, with an even tension, at an average speed of removal of approximately 300 mm/min and at an angle of approximately 50° (0 min value). In each case one of the three samples is removed immediately after having been pressed on, a second after a rest time of 5 min, and the last one after 30 min. As the result, removal can be observed as occurring either with complete or partial transfer of the adhesive or without transfer of the adhesive. This transfer is that of the adhesive from the carrier to the substrate, the adhesive detaching from the carrier without splitting the latter. Removal of the adhesive without transfer is characterized in that, after the three adhesive tape strips have been removed, there is no point at which substantial transfer of the adhesive has taken place. The tabulated results indicate in each case the percentage area of measured occurrence of transfer.

The results obtained of base adhesive 1 for different concentrations of polar-modified polydialkylsiloxane are set out in Table 1.

The results obtained of base adhesive 2 for different concentrations of polar-modified polydialkylsiloxane are set out in Table 2.

The results obtained for different adjuvants with base adhesive 1 are set out in Table 3.

TABLE 1

| Amount | | | | | | | | |
|---|---|---|---|---|---|---|---|---|
| [% by | Bond | Rolling | Holding power | | | Transfer | | |
| weight] of | strength | distance | with 5 N [min] | | | [%] | | |
| Byk 306 | [N/cm] | [mm] | on SRP | on TDP | Repulpability | 0 min | 5 min | 30 min |
| 0.0 | 3.8 | 19 | >1200 | >1200 | + | 100 | 100 | 100 |
| 0.2 | 3.7 | 54 | >1200 | >5600 | + | 85 | 90 | 95 |
| 0.4 | 3.6 | 82 | >1200 | >5600 | + | 70 | 80 | 85 |
| 0.6 | 2.4 | 156 | >1200 | >5600 | + | 35 | 50 | 50 |
| 0.8 | 2.8 | 159 | >1200 | >5600 | + | 15 | 15 | 15 |
| 1.0 | 2.0 | 224 | 818 | 4390 | + | 10 | 5 | 5 |

TABLE 2

| Amount | | | | | | | | |
|---|---|---|---|---|---|---|---|---|
| [% by | Bond | Rolling | Holding power | | | Transfer | | |
| weight] of | strength | distance | with 5 N [min] | | | [%] | | |
| Byk 306 | [N/cm] | [mm] | on SRP | on TDP | Repulpability | 0 min | 5 min | 30 min |
| 0.0 | 4.1 | 14 | 153 | 1201 | + | 100 | 100 | 100 |
| 0.2 | 3.8 | 48 | 98 | 897 | + | 90 | 90 | 95 |
| 0.4 | 3.8 | 79 | 121 | 856 | + | 75 | 80 | 80 |
| 0.6 | 2.9 | 130 | 164 | 869 | + | 30 | 35 | 30 |
| 0.8 | 2.8 | 145 | 211 | 764 | + | 10 | 15 | 20 |
| 1.0 | 2.4 | 189 | 198 | 870 | + | 20 | 15 | 25 |

TABLE 3

| | | Amount | Transfer | | | |
|---|---|---|---|---|---|---|
| Adjuvant | Type | [% by wt.] | 0 min | 5 min | 30 min | Repulpability |
| “none” | | 0.0 | 100 | 100 | 100 | + |
| Zonyl FSG | nonionic | 0.2 | 90 | 80 | 80 | |
| Zonyl FSG | fluoropolymer | 1.0 | 80 | 85 | 90 | + |
| BYK-358N | acrylate | 0.2 | 80 | 90 | 90 | |
| BYK358N | copolymer | 1.0 | 80 | 85 | 90 | + |
| BYK-306 | polyether-modified | 0.2 | 85 | 90 | 95 | |
| BYK-306 | polydimethylsiloxane | 1.0 | 10 | 5 | 5 | + |
| BYK-388 | fluorine-modified | 0.2 | 70 | 75 | 90 | |
| BYK-388 | polyacrylate copolymer | 1.0 | 85 | 80 | 95 | + |
| BYK-322 | aralkyl-modified | 0.2 | 70 | 85 | 90 | |
| BYK-322 | polymethylalkylsiloxane | 1.0 | 65 | 80 | 90 | + |

Tables 1 and 2 reveal that through the use of a modified polydialkylsiloxane for both acrylate-based adhesives, even with an amount of 0.2% by weight of the 12% strength solution, the frequency of transfer is significantly reduced. The higher the amount of modified polydialkylsiloxane added to the adhesive, the more pronounced this effect. Accordingly, the inventive adjuvant decisively improves the anchorage of the adhesive on the paper carrier. A considerable improvement in anchorage, indeed, is observed above an amount of 0.6% by weight of the 12% strength solution.

The holding power and repulpability are affected not at all, or at most only to a small extent, by the added modified polydialkylsiloxane. Thus on both paper media, even with high fractions of adjuvant, the holding powers are at a virtually unchanged high level.

Surprisingly, however, there is a substantially smaller decrease in bond strength than expected. Before the experiments were carried out it was assumed that the admixing even of very small amounts of modified polydialkylsiloxane would necessarily result in a drastic decrease in the bond strength of the overall acrylate-based adhesive. Such a decrease, however, was not observed. On the contrary, even with the adjuvant added at 0.8% by weight of the 12% strength solution, the reduction in the bond strength was only small.

The adhesive property most heavily affected by the addition of the adjuvant of the invention is the tack. As a result of admixing the modified polydialkylsiloxane, for instance, the distance travelled by the steel ball is significantly extended, indicating a sharp decrease in tack. In spite of everything, the addition of less than 0.8% by weight of the 12% strength solution still resulted in an outstanding tack on the part of the acrylate-based adhesive. Only above 5% by weight of the 12% strength solution was the tack assessed as being no longer adequate.

Accordingly, the use of a modified polydialkylsiloxane allows the adhesive to be joined stably to coated joining surfaces with retention of the thickness and weight per unit area of the adhesive coating, without any resultant significant deterioration in the other, adhesionally relevant properties of the acrylate-based adhesive, and without any deterioration in strength properties such as ultimate tensile strength or breaking elongation on the part of a sheetlike structure produced using the acrylate-based adhesive. In particular it is possible to achieve a sharp reduction in the frequency of transfer of the adhesive on detachment from the joining surface.

From Table 3 it is apparent that only the use of BYK-306 and BYK-322 results in a reduction in the frequency of transfer, and therefore that only these substances produce an increase in the stability of the join between acrylate-based adhesive and porous carrier. When other, typical additives are used to anchor printing inks and paints, there is no perceptible reduction in the frequency of transfer, within the experimentally determinable limits, as compared with an acrylate-based adhesive without such adjuvants. Since the joining surface is a polyvinyl alcohol-modified surface of paper, the improvement of the anchorage when a polar-modified polydialkylsiloxane is used is more pronounced than in the case of the apolar-modified polydialkylsiloxane. For the acrylate-based adhesive with the polar-modified polydialkylsiloxane, particularly in the case of a high level of addition of 1.0% by weight of the 12% strength solution, the transfer of the adhesive is lower from virtually 100% to approximately 5% immediately after adhesive bonding and after a prolonged rest time. The repulpability of the acrylate-based adhesives, in contrast, was not perceptibly adversely affected by any of the adjuvants used.

1. An adhesive composition comprising an acrylate-based base adhesive and additives, wherein the additives include at least one modified polydialkylsiloxane.

2. An adhesive composition according to claim 1, wherein the adhesive being a 100% system.

3. An adhesive composition according to claim 1, the adhesive being a solvent-based adhesive, preferably with a solvent fraction of 20% to 90% by weight.

4. An adhesive composition according to claim 1, wherein the at least one modified polydialkylsiloxane has as its modification side chains including polar groups.

5. An adhesive composition according to claim 4, wherein the side chain including polar groups is a polyether side chain.

6. An adhesive composition according to claim 5, wherein the polyether side chain includes alkanediols with a linear carbon chain which are linked to one another via ether bonds, and is joined via an alkylene chain to the polysiloxane main chain.

7. An adhesive composition according to claim 1, wherein the at least one modified polydialkylsiloxane has as its modification alkyl side chains substituted by aryl groups.

8. An adhesive composition according to claim 1, wherein the modified polydialkylsiloxane is a modified polymethylalkylsiloxane.

9. An adhesive composition according to claim 1, wherein the modified polydialkylsiloxane is a modified polydimethylsiloxane.

10. An adhesive composition according claim 1, wherein the at least one modified polydialkylsiloxane is present in the acrylate-based adhesive at a fraction of at least 0.005% and not more than 2% by weight.

11. An adhesive composition according claim 1, wherein the base adhesive comprises a parent polymer based on acrylic monomers selected from the group encompassing acrylic acid, methacrylic acid, butyl acrylate and ethylhexyl acrylate vinyl monomers and mixtures thereof.

12. An adhesive composition according claim 1, the base adhesive being a pressure-sensitive adhesive.

13. Adhesively bondable sheetlike structure having at least one adhesive coating, the adhesive coating comprising at least one acrylate-based adhesive according to claim 1.
